(19) United States
(12) Patent Application Publication
(10) Pub. No.: US 2007/0051796 A1
(43) Pub. Date: Mar. 8, 2007

(54) Goods sales management system and goods sales management method

(76) Inventor: Wataru Yoshizaki, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 10/569,956

(22) PCT Filed: Aug. 4, 2004
(86) PCT No.: PCT/JP04/11171

§ 371 Date: Feb. 28, 2006

(30) Foreign Application Priority Data
Aug. 29, 2003 (JP) 2003-306011

(51) Int. Cl. G06F 7/08

(52) U.S. Cl. 235/381

(57) ABSTRACT

A goods sales management system includes a plurality of goods vending machines 1 having a container capable of storing a plurality of goods and a vending machine management apparatus 80 connected to the goods vending machines 1 via a communication line. The goods vending machine 1 includes a time adjustment management unit 64 for making the time managed by itself coincide with the time information managed by the vending machine management apparatus 80, a delivered-goods number counting unit 63 for counting the number of the goods delivered from the container, a goods number setting unit 62 for setting the number of the goods storable in the container, and the information transmitter/receiver unit 65. The information transmitter/receiver unit 65 transmits a request for restocking the goods and the time managed by the goods vending machines 1 to the vending machine management apparatus 80 when the number of the stored goods obtained by subtracting the number counted by the delivered-goods number counting unit 63 from the number set by the goods number setting unit 62 is less than the predetermined number of the remaining goods. The time managed by the vending machine management apparatus 80 coincide with the time managed by the goods vending machine 1. For this reason, it is possible to avoid the loss of the business opportunities for selling the good, and grasp the sales of the goods with accuracy.

### TECHNICAL FIELD

The present invention relates to a goods sales management system and a goods sales management method comprising a plurality of goods vending machines provided with a container capable of storing a plurality of goods and a vending machine management apparatus connected to the goods vending machines via a communication line for managing the goods vending machines.

### BACKGROUND ART

As is well known, the conventional goods vending machines include a retail vending machine for selling toys, confectionary or dolls contained in a capsule (hereinafter referred to as a “retail vending machine”). The retail vending machine has a storing portion for containing a plurality of capsules storing goods, an ejection port provided below the storing portion for ejecting the capsules, a handle, which is rotated when ejecting the capsules contained in the storing portion into the ejection port, provided between the storing portion and the ejection port, and a money throw-in port for receiving money.

The retail vending machines meet a small installation space, and therefore are placed at surplus spaces in a shopping center, at stores or the like. The retail vending machines are also set at places where a manager of sales does not always stay, because the retail vending machines are usually capable of operating without an electric supply.

As each retail vending machine is formed as one sales unit, the proceeds are individually stored in each vending machine. Therefore, the manager must collect the proceeds one by one after unlocking each safe of the vending machine at each time of collecting the money, so that such collecting works are very troublesome. In order to avoid such troublesome collecting works, there appear some different types of the retail vending machines with other types of structures in which a plurality of vending machines are formed as one sales unit, and a single money throw-in-port is provided to receive money from the plurality of vending machines. These vending machines are provided with a switch section corresponding to each retail vending machine in the vicinity of the money throw-in port, and through operating the switch section, the same effects can be obtained as the money is thrown into each vending machine.

Every retail vending machine contains the capsules storing the goods in the storing portion thereof, and delivers the predetermined number (for example, 1) of the goods through the ejection port every time the money is thrown therein. Sensors or switches are provided at the bottom of the storing portion for detecting that there are no more goods therein so that it is possible to inform customers of the stockout when the goods are sold out, and stop selling the goods. Valuable business opportunities for selling the goods, however, will be lost if it takes a long time to restock the goods after the goods are sold out. Although the loss of the business opportunities can be prevented by frequent restocking by the manager, such restocking operations will go to waste, and efficiency of the restocking operations decreases if the sales of the goods are unpredictably severer. As a result, timing for restocking the goods must depend on experience and sense of the manager.

Japanese Patent application Laid-open No. 2000-76526 (see Pages 3-4, FIG. 1) proposes a terminal calling type sales management system, in which a plurality of vending machines are connected to an information collecting apparatus for controlling the plurality of vending machines via a communication line, and the vending machines make the line connection with the information collecting apparatus when the goods are sold out, then data indicating the stockout is transmitted. According to the above-mentioned system, it is possible to find out the stockout of the goods promptly, and avoid the loss of the valuable business opportunities for selling the goods.

### DISCLOSURE OF THE INVENTION

### Problems to be Solved by the Invention

In the conventional sales management system, the data indicating the stockout is transmitted to the information collecting apparatus when the goods are sold out. However, there are no measures taken against the problem of the loss of the business opportunities, which occurs while the goods are not available after the stockout until the goods are restocked.

Because the conventional sales management system does not manage time when the goods are sold out, it is impossible to obtain sales information including the time of the stockout, interval time in which the stockout occurs, or the like, and therefore it is difficult to grasp sales condition of the goods. For these reasons, the conventional sales management system has the following problem. Suppose that some vending machines run out of the goods at night, while others run out of the goods during the day. Because it is impossible to know time when the goods are sold out, it is difficult to define a priority of the vending machines to be restocked, and therefore perform the restocking operations effectively.

The present invention is proposed to address the foregoing problems, and provided with the goods sales management system having the plurality of goods vending machines and the vending machine management apparatus connected to the goods vending machines via the communication line. It is thus an object of the present invention to provide a goods sales management system and a goods sales management method capable of avoiding the loss of the valuable business opportunities for selling the goods, which occurs while the goods are not available after the stockout until the goods are restocked, and of collecting the sales information of the goods with accuracy.

### MEANS FOR SOLVING THE PROBLEMS

The invention of claim 1 is characterized by a goods sales management system having a plurality of goods vending machines provided with a container for storing a plurality of goods, respectively, and a vending machine management apparatus for controlling the plurality of goods vending machines, the vending machine management apparatus being connected to each of the plurality of goods vending machines via a communication line, wherein the vending machine management apparatus comprises time information transmitting means for transmitting time managed by itself as time information to each of the plurality of goods vending machines. Each of the goods vending machines comprises: time adjustment management means (for example, a time adjustment management unit 64 of the present embodiment) for managing time as time information and making the managed time coincide with the time information managed by and transmitted from the vending machine management apparatus; goods delivering means (for example, a goods delivering unit 13 of the present embodiment) for delivering the goods from the container; delivered-goods number counting means (for example, a delivered-goods number counting unit 63 of the present embodiment) for counting an actual number of the goods delivered by the goods delivering means; goods number setting means (for example, a goods number setting unit 62 of the present invention) for setting a maximum number of the goods storable in the container in accordance with a capacity of the container; and information transmitting/receiving means (for example, a information transmitter/receiver unit 65 of the present invention) for transmitting a request for restocking the goods to the vending machine management apparatus when a number obtained by subtracting the number counted by the delivered-goods number counting means from the number set by the goods number setting means is less than a predetermined number of remaining goods. In such a system, the goods vending machine transmits the time information managed by itself as well as the request for restocking the goods to the vending machine management apparatus by the information transmitting/receiving means, but, on the other hand, the vending machine management apparatus transmits the time information managed thereby to the goods vending machine as a transmitter of the request for restocking the goods by the time information transmitting means when receiving the request for restocking the goods, so that the time adjustment management means of the goods vending machine makes the time managed by itself coincide with the time information transmitted from the vending machine management apparatus.

The invention of claim 2, in the goods sales management system according to claim 1, is characterized in that the vending machine management apparatus further comprises response means (for example, a response unit 81 of the present invention) for transmitting a response signal when receiving the request for restocking the goods, wherein the goods vending machine receives the response signal from the response means after transmitting the request for restocking the goods, then cuts off the communication line with the vending machine management apparatus.

The invention of claim 3, in the goods sales management system according to claim 1 or 2, is characterized in that the containers of the goods vending machines are structured to be capable of separately containing a plurality of kinds of goods in each container. Each of the goods vending machines further comprises a sales management unit for delivering the goods by the goods delivering means in accordance with a selecting operation of desired kinds of goods by a customer after receiving paid money.

The invention of claim 4 is characterized by a goods sales management method which uses a goods sales management system having a plurality of goods vending machines provided with a container for storing a plurality of goods, respectively, and a vending machine management apparatus connected to each of the plurality of goods vending machines via a communication line for controlling the plurality of goods vending machines, and through the method, sales information of goods in the plurality of goods vending machines is managed. The method comprises the steps of: setting a maximum number of the goods storable in the container of the goods vending machine in accordance with a capacity of the container; transmitting a request for restocking the goods and time information managed by the goods vending machine to the vending machine management apparatus when a number obtained by subtracting an actual number of the goods delivered by the goods vending machine from the maximum number of the goods set in the goods vending machine is less than a predetermined number of remaining goods: transmitting time information managed by the vending machine management apparatus to the goods vending machine as a transmitter of the request for restocking the goods when receiving the request for restocking the goods; and making the time information managed by the goods vending machine coincide with the time information transmitted from the vending machine management apparatus.

According to the goods sales management system of the present invention defined by claim 1, the vending machine management apparatus receives the request for restocking the goods and the time information managed by the goods vending machine when the number obtained by subtracting the number counted by the delivered-goods number counting means from the maximum number set by the goods number setting means is less than the predetermined number of the remaining goods. The vending machine management apparatus can be informed of the time when the container has few stocks of the goods. Therefore, it is possible to know the sales condition of the goods and to predict time when the stockout occurs by calculating a period when a stock shortage of the goods occurs. The goods can be restocked before the goods are sold out so as to prevent situation where the goods are not available after the stockout until the goods are restocked. The problem of the loss of the valuable business opportunities for selling the goods can be avoided. According to the goods sales management system of the present invention, the sales condition of the goods can be grasped (the sales condition of the goods is assessed by length of time between the current restocking request and the next one). When a plurality of requests for restocking the goods are transmitted from the plurality of goods vending machines, it is possible to define a priority of the goods vending machines to be restocked, and to perform the restocking operations effectively. When receiving the request for restocking the goods, the vending machine management apparatus transmits the time information to the goods vending machine as a transmitter of the request for restocking the goods. The goods vending machine receives the time information to make the time managed by itself coincide with the time information. Accordingly, the time managed by the goods vending machine is approximately equal to the time managed by the vending machine management apparatus. For this reason, the time information can be accurate, which is transmitted together with the request for restocking the goods of the goods vending machines, and is gathered in the vending machine management apparatus, and therefore the sales condition of the goods can be grasped more precisely.

According to the goods sales management system of the present invention defined by claim 2, the goods vending machine receives a response signal from response means of the vending machine management apparatus after transmitting the request for restocking the goods, then cuts off the communication with the vending machine management apparatus. Thus, the goods vending machine can accurately confirm that the request for restocking the goods is transmitted to the vending machine management apparatus, and also shorten the transmitting time of the request for restocking the goods.

According to the goods sales management system of the present invention defined by claim 3, the containers of the plurality of goods vending machines are capable of separately containing the plurality of kinds of goods in each container. The goods vending machines include the sales management unit for delivering the goods by the goods delivering means in accordance with the selecting operation of the desired kinds of goods by the customer after receiving paid money. The plurality of goods vending machines are regarded as the one sales unit, and the proceeds are collectively received in a receiving portion. Therefore, there is no need to collect the proceeds in each goods vending machine, and it is possible to reduce labor for collecting the proceeds. Because the goods vending machine has the single receiving portion for receiving the proceeds, the goods vending machine can have more space inside, which improves degrees of freedom for designing the goods vending machine.

According to the goods sales management method of the present invention defined by claim 4, the maximum number of the goods storable in the container of the goods vending machine is set in accordance with the capacity of the container. The goods vending machine transmits the request for restocking the goods and the time information managed by the goods vending machine to the vending machine management apparatus, when the number obtained by subtracting the number of the goods delivered from the goods vending machine from the maximum number of the goods set in the goods vending machine is less than the predetermined number of the remaining goods. The vending machine management apparatus can be informed of the time when there are few stocks of the goods. Thus, it is possible to calculate a period when a stock shortage of the goods occurs, to know the sales condition of the goods, and to easily predict the time when the stockout occurs. Accordingly, the goods can be restocked before the goods are sold out so as to prevent the situation where the goods are not available after the stockout until the goods are restocked. The problem of the loss of the valuable business opportunities for selling the goods can be avoided. According to the goods sales management system of the present invention, with which the sales condition of the goods can be grasped, it is possible to define the priority of the goods vending machines to be restocked and to perform the restocking operations effectively, when the plurality of requests for restocking the goods are transmitted from the plurality of goods vending machines. According to the goods sales management method of the present invention, when receiving the request for restocking the goods, the vending machine management apparatus transmits the time information managed by itself to the goods vending machine as the transmitter of there quest for restocking the goods. The goods vending machine receives the time information to makes the time managed by itself coincide with the time information. Thus, the time managed by the goods vending machine can be approximately equal to the time managed by the vending machine management apparatus. Accordingly, the time information can be accurate, which is transmitted together with the request for restocking the goods of the goods vending machines, and is gathered in the vending machine management apparatus, and therefore the sales condition of the goods can be grasped more precisely.

### EFFECT OF THE INVENTION

According to the goods sales management system and the goods sales management method of the present invention as described above, the vending machine management apparatus receives the request for restocking the goods and the time managed by the goods vending machine when the goods vending machine has few stocks of the goods. It is possible to know the sales condition of the goods by calculating a period when a stock shortage of the goods occurs, and to easily predict the time when the stockout occurs. Therefore, the goods can be restocked before the goods are sold out so as to prevent the situation where the goods are not available after the stockout. The problem of the loss of the valuable business opportunities for selling the goods can be avoided. Suppose that the plurality of requests for restocking the goods are transmitted from the plurality of goods vending machines. It is possible to define the priority of the goods vending machines to be restocked, and to perform the restocking operations effectively, because the time when the stockout occurs can be predicted. When receiving the request for restocking the goods, the vending machine management apparatus transmits the time information managed by itself to the goods vending machine as the transmitter of the request for restocking the goods. The goods vending machine receives the time information to make the time managed by itself coincide with the time information. Accordingly, the time, which is transmitted together with the request for restocking the goods of the goods vending machine and is gathered in the vending machine management apparatus, can be approximately equal to the time managed by the vending machine management apparatus, and therefore the sales condition of the goods can be grasped more precisely.

### BRIEF DESCRIPTION OF THE DRAWINGS

FIG. 1 illustrates a goods sales management system according to an embodiment of the present invention.

FIG. 2 is a perspective view of a retail vending machine provided in the goods sales management system shown in FIG. 1.

FIG. 3 is a block diagram of the retail vending machine.

FIG. 4 is a flowchart showing a goods sales management method according to an embodiment of the present invention.

### BEST MODE FOR CARRYING OUT THE PRESENT INVENTION

Hereinafter, embodiments of the present invention will be described with reference to the accompanying drawings. According to the embodiments of a goods sales management system of the present invention, a description will be given of a goods vending machine provided with a plurality of retail vending units including a plurality of capsules containing goods therein. Initially, before explaining a goods sales management method according to the present invention, an explanation is provided for the goods sales management system, to which the goods sales management method is applied.

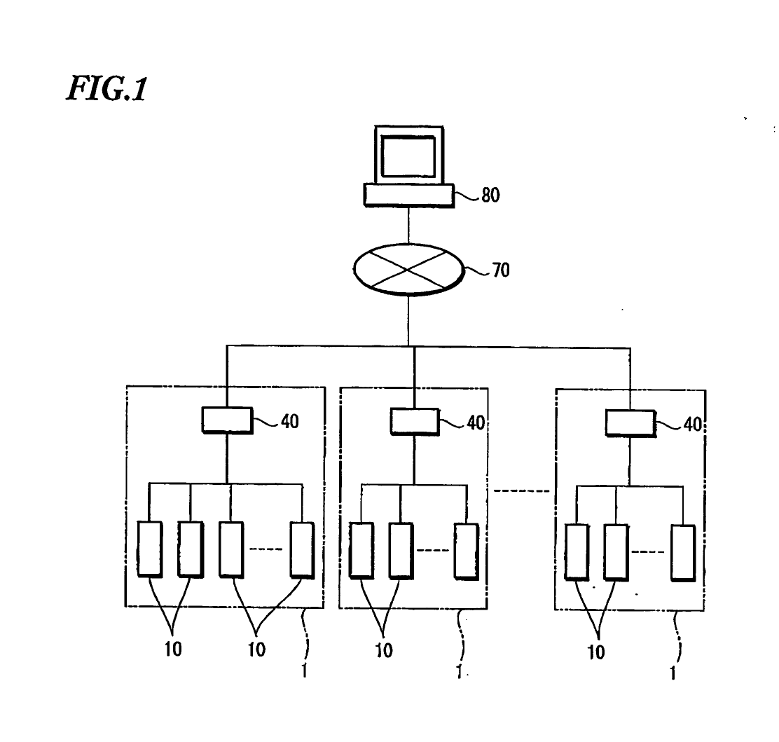

The goods sales management system of the present invention, as shown in FIG. 1, comprises: a plurality of goods vending machines 1 each having a plurality of retail vending units 10; and a vending machine management apparatus 80 connected to each of the plurality of goods vending machines 1 via a communication line 70 for controlling the goods vending machines 1.

The communication line 70 connected between the plurality of goods vending machines 1 and the vending machine management apparatus 80 can be either one of wire communications or radio networks, for example, public line networks, local area networks (LAN), Personal Handy-phone Systems (PHS), cellular telephone networks, or radio communication networks.

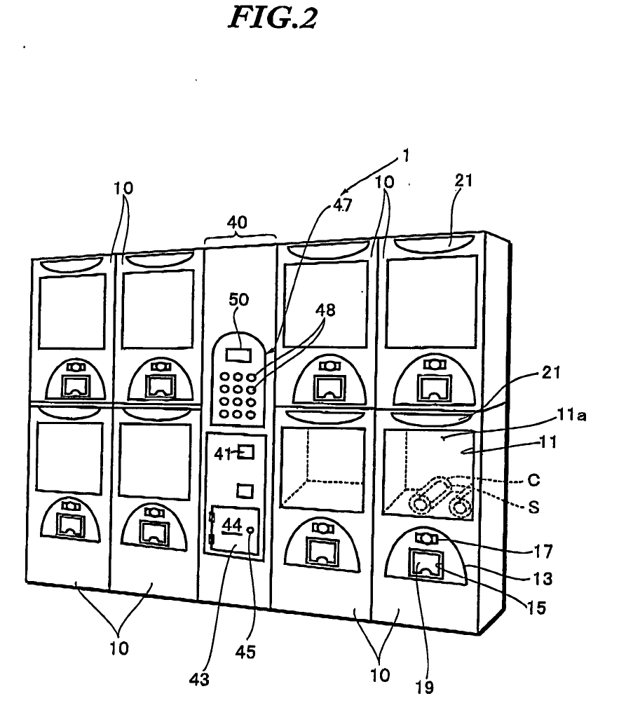

The goods vending machine 1, as shown in FIG. 2, comprises; a sales management portion 40 provided in the intermediate portion thereof for controlling a sales management to eject the goods in response to a selecting operation of desired goods after receiving money for the goods: and the eight retail vending units 10 provided on both sides of the sales management portion 40. The retail vending units 10 of each side are arranged in two rows each on upper and lower shelves. The number of the retail vending units 10 to form the goods vending machine 1 is not limited to eight. There is no specific limitation as long as there are two or more retail vending units 10.

The retail vending unit 10 has a rectangular parallelepiped shape, and has a container 11 at an upper portion for containing the plurality of goods and an ejection port 13 provided at a lower portion under the container 11 for ejecting goods S contained in the container 11. A front portion 11a of the container 11 is formed of a transparent panel, and the container 11 is box-shaped. Accordingly, the inside of the container 11 can be seen from a front position of the retail vending unit 10 via the front portion 11a. The goods S stored in the container 11 are respectively contained in a capsule C, which can be divided and is formed of transparent materials. Accordingly, a customer (not shown) can see the goods S in the capsule C through the front portion 11a.

The ejection port 13 includes a good stake-out port 15 provided at a lower position under the container 11, which is open to the front, and a handle 17 to be rotated when the goods S contained in the container 11 are delivered therefrom. A rotational movement of the handle 17 is restricted and allowed by a locking mechanism (not shown), a more detailed description on which is given below. The capsule C contained in the container 11 can be delivered to a communicating passage (not shown) communicating with the goods take-out port 15 by rotating the handle 17. Further, a rotation detecting switch (not shown) is provided with the handle 17 for sensing the rotational movement of the handle 17. That is, the rotational movement of the handle 17 to be detected by the rotation detecting switch represents that the capsule C (goods) contained in the container 11 is taken out from the container 11.

A lid portion 19 is provided at the goods take-out port 15 so as to be freely swung up and down in a vertical direction by pivoting an upper position thereof. During non-operation of the lid portion 19, the goods take-out port 15 is covered with the lid portion 19 extending downwardly. When the lid portion 19 is pulled up, the goods take-out port 15 is exposed to be open, and it becomes possible to take out the capsule C (goods S). There provided a selection lamp 21 on a front surface of the retail vending unit 10 at an upper position above the container 11. A detailed explanation about the operational movement of the selection lamp 21 will be described hereinafter. When the retail vending unit 10 containing the desired goods is selected by the sales management portion 40, the selection lamp 21 of the selected retail vending unit 10 flashes.

The sales management portion 40 has a money throw-in port 41 for receiving money for the goods S, a safe 43 for containing the money (coins) thrown from the money-throw-in port 41, a goods selection operation switch 47 for operating a selection of the retail vending unit 10 storing the goods which is desired to be bought by the customer, and a price display unit 50 for indicating the amount of money thrown through the money throw-in port 41. The money throw-in port 41 is configured to receive the coins, but may be configured to receive paper money. The safe 43 is provide with a front door 44 at a front position thereof for being swingably open to front and rear directions, and the front door 44 has a key 45 attached therein. The goods selection operation switch 47 is provided with a plurality of operation buttons 48 to be pushed, and each button 48 has a stamped natural number (1, 2, 3, . . . , 9) which is different from each other. On the other hand, each of the retail vending units 10 is given a different natural number, and the numbers given to the retail vending units 10, not shown in the drawing, are shown in the vicinity of the goods selection operation switch 47, the retail vending units 10, or the like, to be easily recognized by the customers. Therefore, as the customer pushes the operation buttons 48 corresponding to the number of the retail vending unit 10 containing the desired goods, it is possible to designate the retail vending unit 10 storing the goods which the customer wants to buy.

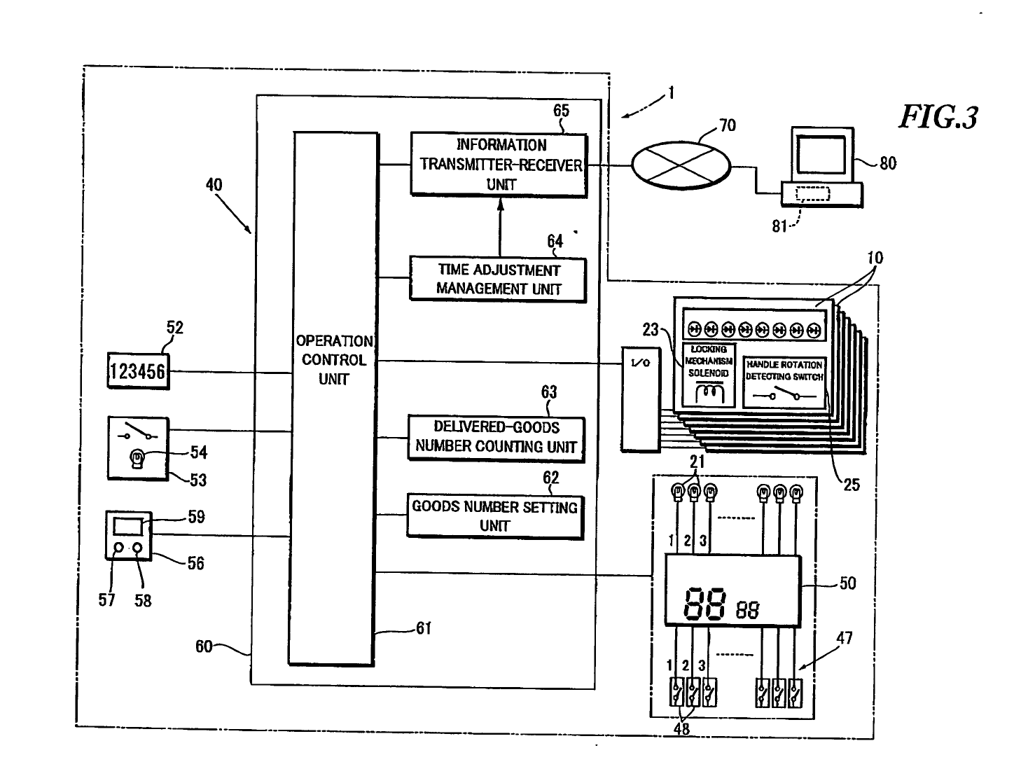

The sales management portion 40, as shown in FIG. 3, is provided with a coin counter 52 for counting the number of the coins thrown from the money throw-in port 41, a coin selector 53 for detecting an improper coin thrown into the money throw-in port 41 or for warning when the safe 43 is full of the coins, a goods number setting switch 56 for setting the maximum number of the goods storable in the container 11 of the retail vending unit 10 in accordance with a capacity thereof, and a controller 60 described below in details. A selector lamp 54 provided in the coin selector 53 lights up when an unusable coin is thrown into the money throw-in port 41 or when the safe 43 is full of the coins. The goods number setting switch 56 has a setting button 57 for selecting the maximum number of the goods stored in each container 11 of the plurality of retail vending units 10, a reset button 58 for resetting the number of the goods delivered from the container 11 to zero, and a setting display portion 59 for displaying the selected and set numbers. The sales management portion 40 contains the coin counter 52, the coin selector 53, the goods number setting switch 56 and the controller 60.

The controller 60 exchanges the information with the vending machine management apparatus 80 via the communication line 70, and has a function to deliver the required goods from the retail vending unit 10. The controller 60 is provided with an operation control unit 61, a goods number setting unit 62, a delivered-goods number counting unit 63, a time adjustment management unit 64, and an information transmitter-receiver unit 65. The goods number setting unit 62 is a memory apparatus for setting a selected number selected by the setting button 57 of the goods number setting switch 56. The delivered-goods number counting unit 63 is a counter for counting the number of the goods delivered from the container 11. The number of the goods remained in the container 11 can be calculated by subtracting the number counted by the delivered-goods number counting unit 63 from the number set by the goods number setting unit 62, A description is given later of a management of the number of the remaining goods.

The time adjustment management unit 64 manages time, and also functions to make the managed time coincide with time transmitted from the vending machine management apparatus 80. The time information managed by the time adjustment management unit 64 may include the time only, or both the time and the date. The information transmitter-receiver unit 65 transmits a terminal number assigned to each goods vending machine 1 to the vending machine management apparatus 80 by a dialing transmission via the communication line 70. The information transmitter/receiver unit 65 transmits a request for restocking the goods to the vending machine management apparatus 80 when the number obtained by subtracting the number counted by the delivered-goods number counting unit 63 from the number set by the goods number setting unit 62 is less than the predetermined number of the remaining goods. The request for restocking the goods includes the number information assigned to the retail vending unit 10. The information transmitter/receiver unit 65 requests to transmit the time information managed by the vending machine management apparatus 80 when confirming that the vending machine management apparatus 80 receives the request for restocking the goods. The terminal number may be assigned from the vending machine management apparatus 80 via the communication line 70 after setting the goods vending machine 1 at sales sites, or be assigned individually in advance before setting the goods vending machine 1.

The operation control unit 61 controls to display a price on the price display unit 50 in accordance with the numbers calculated by the coin counter 52 and to flash or turn on a light of the selection lamp 21 of the retail vending unit 10 in response to pushing operations of the operation button 48 of the goods selection operation switch 47. Furthermore, the operation control unit 61 releases a locking condition of the handle 17 by controlling electric supply to a solenoid 23 which constitutes a part of the locking mechanism included in the retail vending unit 10 and allows the rotational movement of the handle 17 to eject the goods, when it is determined that a desired retail vending unit 10 is selected by the goods selection operation switch 47, and the money thrown in exceeds the price of the goods contained in the selected retail vending unit 10. The operation control unit 61 controls the goods number setting unit 62 to set the number selected by the setting button 57 of the goods number setting switch 56 in each retail vending unit 10. The operation control unit 61 further makes the delivered-goods number counting unit 63 count how many goods are delivered in each retail vending unit 10 after the reset button 58 of the goods number setting switch 56 reset the number of the goods. It is determined if the goods are delivered or not depending on presence or absence of ON signal from the handle rotation detecting switch 25.

The operation control unit 61 controls the information transmitter/receiver unit 65 to transmit the request for restocking the goods to the vending machine management apparatus 80, when the number obtained by subtracting the number counted by the delivered-goods number counting unit 63 from the number set by the goods number setting unit 62 is less than the predetermined number of the remaining goods. At this time, the operation control unit 61 controls the information transmitter/receiver unit 65 to transmit the time information managed by the time adjustment management unit 64 as well as the request for restocking the goods to the vending machine management apparatus 80. In other words, the request for restocking the goods is transmitted to the vending machine management apparatus 80 in accordance with calls from the goods vending machine 1.

On the other hand, the vending machine management apparatus 80 connected to the goods vending machine 1 via the communication line 70 memorizes the request for restocking the goods transmitted from the goods vending machine 1 and the time information managed by the goods vending machine 1 in an internal memory apparatus thereof, and displays the information when necessary. The vending machine management apparatus 80 is provided with a response unit 81 for transmitting a response signal to the goods vending machine 1 when receiving the request for restocking the goods from the goods vending machine 1. The vending machine management apparatus 80 manages the time, and transmits the time information managed by itself to the respective goods vending machines 1 in response to a demand of the time information therefrom. The time information managed by the vending machine management apparatus 80 is not limited to the time, but may include both the time and the date.

The explanation about a goods sales management method according to the above mentioned goods sales management system is given as follows. The goods vending machine 1 is first set at an initial condition. That is, a manager (not shown) of the goods vending machine 1 stores the goods in each container 11 of the plurality of retail vending units 10 so as to fill up the container 11. As shown in FIG. 3, the manager sets the maximum number of the goods to be stored in each container 11 of the plurality of retail vending units 10 by selecting the setting button 57 of the goods number setting switch 56, and sets the number of the goods delivered from the container 11 to zero by operating the reset button 58, After the reset button 58 is pushed, the goods number setting switch 56 provided with the reset button 58 may, through the operation control unit 61, display the number of the remaining goods on the setting display portion 59 after the goods are delivered from the container 11, and the number of the remaining goods is recorded in the goods number setting unit 62.

The customer puts the money into the money throw-in port 41 shown in FIG. 2, and then pushes the operation buttons 48 of the goods selection operation switch 47 in order to select the retail vending unit 10 containing the desired goods therein. When the money is thrown into the money throw-in port 41, the coin counter 52 counts the number of the coins. The money amount in accordance with the counted number is displayed on a price display unit 50 by the operation control unit 61 of the controller 60. When the operation button 48 is pushed, the selecting lamp 21 of the retail vending unit 10 corresponding to the pushed operation button 48 flashes. As a result, the customer can make certain whether the operation button 48 is correctly selected by visually checking the flashing selecting lamp 21 of the retail vending unit 10.

When the money thrown in is more than the price of the desired goods, the operation control unit 61 releases the locked condition of the handle 17 by means of the locking mechanism. Then, the customer rotates the handle 17 to get the desired goods delivered from the container 11, The delivered-goods number counting unit 63 of the controller 60 adds the number of the delivered goods by one after the handle rotation detecting switch 25 is turned on by rotating the handle 17. In this way, the goods are purchased and then delivered from the container 11. At this moment, the delivered-goods number counting unit 63 counts the number of the goods delivered from the retail vending unit 10 in such a way that the number increases to 1, 2, 3, . . . . When the number obtained by subtracting the number of the goods delivered from the retail vending unit 10 from the number set by the goods number setting unit 62 corresponding to the retail vending unit 10 that deliverers the goods is less than the predetermined number of the remaining goods, the operation control unit 61 commands the information transmitter/receiver unit 65 to transmit the request for restocking the goods to the vending machine management apparatus 80. The delivered-goods number counting unit 63 decreases the number set by the goods number setting unit 62 by one every time the goods are delivered. When the decreasing set number becomes less than the predetermined number of the remaining goods, the operation control unit 61 commands the information transmitter/receiver unit 65 to transmit the request for restocking the goods to the vending machine management apparatus 80.

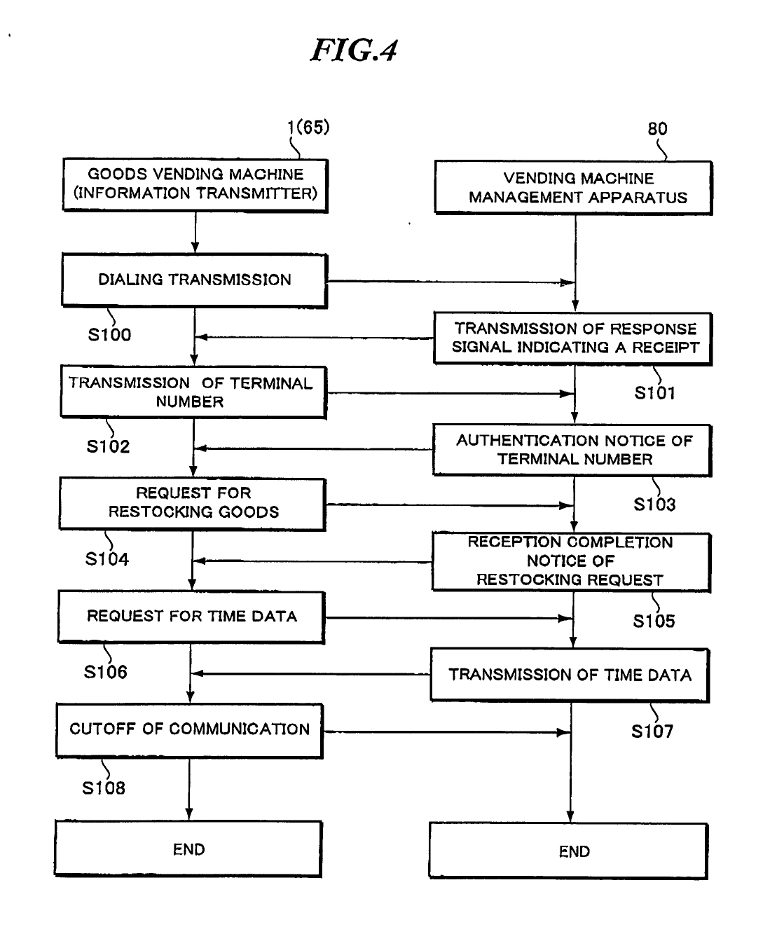

When receiving the command to transmit the request for restocking the goods, the information transmitter/receiver unit 65 makes a dialing transmission to the vending machine management apparatus 80 via the communication line 70 as shown in FIG. 4 (STEP 100). After the vending machine management apparatus 80 is connected with the goods vending machine 1 via the communication line 70, the vending machine management apparatus 80 transmits the response signal indicating a receipt of communication to the goods vending machine 1 (STEP 101). When receiving the response signal indicating the receipt thereof, the information transmitter/receiver unit 65 of the goods vending machine 1 transmits data of the terminal number assigned to the goods vending machine 1 to the vending machine management apparatus 80 (STEP 102) In addition, the terminal number is preferably encrypted for the transmission because a reliability of the information transmitted to the vending machine management apparatus 80 is extremely damaged if the terminal number is known and changed by the third party. After receiving the data of the terminal number, the vending machine management apparatus 80 verifies the terminal number, and sends an authentication notice thereof to the goods vending machine 1 after the authentication of the terminal number (STEP 103).

After receiving the authentication notice of the terminal number from the vending machine management apparatus 80, the goods vending machine 1 transmits the request for restocking the goods to the vending machine management apparatus 80 (STEP 104). When the request for restocking the goods is transmitted to the vending machine management apparatus 80, the time information managed by the time adjustment management unit 64 of the goods vending machine 1 shown in FIG. 3 is transmitted together with the request for restocking the goods. Specifically, the vending machine management apparatus 80 receives the request for restocking the goods including the terminal number of the goods vending machine 1 requiring the restocking and the number of the retail vending unit 10, and the time when the request for restocking the goods is given. Therefore, the vending machine management apparatus 80 can be informed of the time when there are few stocks of the goods in the container 11 of the retail vending unit 10, As a result, it is possible to know sales condition of the goods contained in the retail vending unit 10 and predict time when the stockout occurs by calculating the period when the stock shortage of the goods occurs again after previous restocking. Accordingly, it is possible to restock the goods before the goods are sold out, to prevent the situation where the goods are not available after the stockout until the goods are restocked, and to avoid the problem of loss of valuable business opportunities for selling the goods. According to the goods sales management system of the present invention, with which the sales condition of the goods can be grasped, it is possible to define a priority of the goods vending machines to be restocked and to perform the restocking operations effectively, when the plurality of requests for restocking the goods are transmitted from the plurality of goods vending machines 1.

The vending machine management apparatus 80 actuates the response unit 81 to transmit to the goods vending machine 1 a reception completion notice (response signal) of the restocking request, after receiving the request f or restocking the goods (STEP 105). The goods vending machine 1 receives the reception completion notice of the restocking request, and then requests time data managed by the vending machine management apparatus 80 (STEP 106). Next, the vending machine management apparatus 80 transmits the time information managed by itself to the goods vending machine 1 (STEP 107). The goods vending machine 1 actuates the time adjustment management unit 64 of the goods vending machine 1, shown in FIG. 3, to make the time managed by itself coincide with the time included in the received time information. Accordingly, the time managed by the goods vending machine 1 becomes approximately equal to the time managed by the vending machine management apparatus 80, and the time information can be accurate, which is transmitted together with the request for restocking the goods of the goods vending machines 1, and is gathered in the vending machine management apparatus 80, and therefore the sales condition of the goods in a lot of goods vending machines disposed in various places can be grasped more precisely.

After receiving the reception completion notice of the restocking request from the vending machine management apparatus 80, the goods vending machine 1 cuts off the communication with the vending machine management apparatus 80 (STEP 108). In this way, when the goods vending machine 1 receives the reception completion notice of the restocking request in the communication with the vending machine management apparatus 80, the goods vending machine 1 cuts off the communication with the vending machine management apparatus 80 upon the condition that the goods vending machine 1 receives the time information managed by the vending machine management apparatus 80. Thus, the goods vending machine 1 can accurately confirm that the request for restocking the goods is transmitted to the vending machine management apparatus 80, and the goods vending machine 1 can also shorten transmitting time of the request for restocking the goods to the vending machine management apparatus 80.

According to the goods sales management system and the goods sales management method of the present invention as described above, the vending machine management apparatus 80 receives the request for restocking the goods as well as the time when the request is given, based on which the sales condition of the goods can be grasped precisely. Therefore, the restocking operation of the goods can be effectively performed even when the goods vending machines 1 are disposed across a wide area. As a result, according to the goods sales management system and the goods sales management method of the present invention, it is possible to prevent the loss of the business opportunities for selling the goods, and reduce labor for restocking the goods, compared to the conventional situation where the manager decides timing for restocking the goods in accordance with his or her experience and sense.

### INDUSTRIAL APPLICABILITY

The present invention is also applicable to ordinary automatic vending machines which sell beverages such as a variety of canned drinks, books or magazines, or the like.

1. A goods sales management system having a plurality of goods vending machines provided with a container for storing a plurality of goods, respectively, and a vending machine management apparatus for controlling the plurality of goods vending machines, the vending machine management apparatus being connected to each of the plurality of goods vending machines via a communication line,
wherein said vending machine management apparatus comprises time information transmitting means for transmitting time managed by itself as time information to each of the plurality of goods vending machines,
each of said goods vending machines comprising:
time adjustment management means for managing time as time information and making the managed time coincide with said time information managed by and transmitted from the vending machine management apparatus;
goods delivering means for delivering the goods from the container,
delivered-goods number counting means for counting an actual number of the goods delivered by said goods delivering means,
goods number setting means for setting a maximum number of the goods storable in the container in accordance with a capacity of the container, and
information transmitting/receiving means for transmitting a request for restocking the goods to said vending machine management apparatus when a number obtained by subtracting the number counted by said delivered-goods number counting means from the number set by said goods number setting means is less than a predetermined number of remaining goods,
wherein said goods vending machine transmits said time information managed by itself as well as said request for restocking the goods to said vending machine management apparatus through said information transmitting/receiving means,
wherein said vending machine management apparatus transmits said time information managed thereby to said goods vending machine as a transmitter of said request for restocking the goods by said time information transmitting means when receiving said request for restocking the goods, and
wherein said time adjustment management means of said goods vending machine makes said time managed by itself coincide with said time information transmitted from said vending machine management apparatus.

2. The goods sales management system according to claim 1, said vending machine management apparatus further comprising:
response means for transmitting a response signal when receiving the request for restocking the goods,
wherein said goods vending machine receives the response signal from said response means, after transmitting said request for restocking the goods, then cuts off the communication line with said vending machine management apparatus.

3. The goods sales management system according to claim 1, wherein said containers of said goods vending machines are structured to be capable of separately containing a plurality of kinds of goods in each container, each of said goods vending machines further comprising:
a sales management unit for delivering the goods by said goods delivering means in accordance with a selecting operation of desired kinds of goods by a customer after receiving paid money.

4. A goods sales management method, using a goods sales management system having a plurality of goods vending machines provided with a container for storing a plurality of goods, respectively, and a vending machine management apparatus connected to each of the plurality of goods vending machines via a communication line for controlling the plurality of goods vending machines, in which sales information of the goods in the plurality of goods vending machines is managed, said method comprising the steps of:
setting a maximum number of the goods storable in said container of said goods vending machine in accordance with a capacity of the container,
transmitting a request for restocking the goods and time information managed by said goods vending machine to said vending machine management apparatus when a number obtained by subtracting an actual number of the goods delivered by the goods vending machine from the maximum number of the goods set in the goods vending machine is less than a predetermined number of remaining goods,
transmitting time information managed by said vending machine management apparatus to the goods vending machine as a transmitter of said request for restocking the goods when receiving said request for restocking the goods, and
making said time information managed by said goods vending machine coincide with the time information transmitted from said vending machine management apparatus.

5. The goods sales management system according to claim 2, wherein said containers of said goods vending machines are structured to be capable of separately containing a plurality of kinds of goods in each container, each of said goods vending machines further comprising:
a sales management unit for delivering the goods by said goods delivering means in accordance with a selecting operation of desired kinds of goods by a customer after receiving paid money.
